(19) United States
(12) Patent Application Publication
(10) Pub. No.: US 2001/0047647 A1
(43) Pub. Date: Dec. 6, 2001

(54) Process and device for lubricating an aircraft engine

(76) Inventor: Albert Cornet, Verviers (BE)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/785,016

(22) Filed: Feb. 14, 2001

Related U.S. Application Data
(60) Provisional application No. 60/182,173, filed on Feb. 14, 2000.

(30) Foreign Application Priority Data
May 31, 2000 (EP) 00870118.7

(51) Int. Cl. F02C 7/06

(52) U.S. Cl. 60/39.02; 60/39.08

(57) ABSTRACT

The present invention relates to a process for lubricating an aircraft engine, and preferably a turboreactor engine, comprising at least one shaft (2), in which the pressurization of oil taken from a reservoir (3), the distribution of the oil via a downstream circuit (5) to elements (6) of said engine, and the return of the oil via an upstream circuit (7) to the reservoir (3) are ensured by means of a pump (1, 15, 17), the rotational speed of said pump (1, 15, 17) being variable and adjustable, characterized in that this rotational speed of said pump (1, 15, 17) is preferably regulated by a predetermined law in order to adapt to the actual lubrication needs of said engine.

### SUBJECT OF THE INVENTION

The present invention relates to a process and a device for lubricating an aircraft engine.

### STATE OF THE ART

It is known that aircraft engines are lubricated by an assembly of pumps which, firstly, pressurize the oil taken from the reservoir and then delivered to the engine elements to be lubricated, and, secondly, recover the oil collected in the pan sections of the engine and conveyed to the reservoir. These pumps are all either driven by the same shaft as an “assembly of pumps” or distributed individually in the engine.

For various reasons, these pumps are generally of volumetric or volume displacement type. The simple types, of fixed capacity, such as gear pumps, Gerotor® pumps and vane pumps, are preferred for reasons of simplicity, reliability and lightness.

Like other engine accessories, these pumps are driven by the shaft of the high-pressure body of the engine by means of a more or less complex kinematic chain. The speed of the pumps is thus directly proportional to the rotational speed of this shaft.

Since the drive speed of the pumps is thus at any moment directly proportional to the rotational speed of the engine, and since the pump capacity, i.e. the volumetric displacement, is fixed, the flow rate of oil delivered is not adjustable on running and is thus not adapted to the actual lubrication needs. It depends only on the performance of the pump at the speed set by the engine, under the conditions set by the immediate environment and the upstream and downstream circuits.

The flow rate of oil, and thus the pressure, increase as the rotational speed of the engine increases. If the pressure becomes too great, safety systems, for example pressure reliefs, are actuated to allow the excess oil to escape.

Some constructors add pressure-regulating or pressure-limiting systems to the downstream circuit. However, these systems, which are of passive type, can only stabilize or limit the peak oil pressure at certain speeds.

The lubrication rate of the engine is thus uncontrolled or only poorly controlled and is essentially dependent on the running speed of the engine. However, the oil requirement of the engine is associated with several other parameters, besides the rotational speed of the shaft. These parameters are, in particular, the external pressure and temperature, which are themselves dependent on the altitude, the engine load and the speed variations, which may lead to large thermal transients.

As the oil requirement of the engine on running varies according to a law which is different from that governing the change in the effective flow rate of the pumps, there is a tendency towards sizing these pumps as a function of the most unfavourable operating condition. This results in an oversizing which is occasionally considerable under the other operating conditions. The consequences of this are oversizing of the circuit, of the pump and of its driving elements, a futile consumption of energy, and also the presence in the engine of an excessive amount of oil, which is harmful to the output of the internal elements.

The use in the downstream circuit of systems for controlling the flow rate would not eliminate the energy expenditure and the oversizing of the pumps, but would increase the weight of the system while at the same time reducing its reliability. Similarly, pumps with variable capacity, i.e. variable displacement, which are too heavy, too unreliable and of mediocre output, do not provide an effective solution.

U.S. Pat. No. 5,152,141 proposes a process for electrically driving and managing accessories associated with a gas turbine engine, and in particular the engine's oil pump. Electrical power is supplied to one or more electronic controllers which manage both a starter-generator of the turbine engine and a series of auxiliary electric motors typically coupled to an oil pump, a separator for entering particles, an air cooling system, etc. According to said invention, after starting the main engine, the electronic controller is used to increase the speed of the auxiliary electric motors until they are synchronous with the starter-generator, the rotational speed of which is continuously proportional to that of the turbine engine. Next, the functioning continues while maintaining electrical coupling between the starter-generator and each of these motors. In particular, the speed of the oil pump varies between start-up and the maximum speed of the engine along a predetermined acceleration curve. The acceleration communicated to this pump is chosen in particular to allow optimum lubrication of the moving parts of the turbine engine.

U.S. Pat. No. 5,285,626 discloses a device for pneumatically driving auxiliary turbines, in which the pressurized gas is taken from the gas turbine engine. A controller is associated with each auxiliary turbine so as to be able to control their speed independently. Auxiliary units, including a lubricating device, are connected to the auxiliary turbines via transmissions.

U.S. Pat. No. 4,156,407 relates to an internal combustion engine. Usually, oil pumps and water pumps are driven by mechanical coupling via pulleys and a belt to the crankshaft. In the present case, it is proposed to install a pump in the oil circuit, which can be controlled independently of the rotational speed of the engine, by means of its own electric motor. The speed of the pump is variable and can be modified as a function of the operating conditions, manually or automatically by means of specific control elements.

### OBJECTS OF THE INVENTION

The present invention aims to propose a process and a device for lubricating an aircraft engine, which do not have the drawbacks of the prior art.

In particular, the invention aims to provide a lubricating process and a lubricating device which make it possible to satisfy as far as possible the actual oil requirement of the engine at any moment.

A further aim of the invention is to provide a solution for making the kinematic chain considerably lighter by suppressing the pump driving elements and by simplifying the lubricating circuit and the associated accessories, compared with the prior art.

A further aim of the invention is to provide a solution for using a pump which is hydraulically simple, light and reliable.

Finally, the invention aims to provide a solution which is less expensive than that of the prior art.

### MAIN CHARACTERISTIC ELEMENTS OF THE INVENTION

The present invention relates to a process for lubricating an aircraft engine, and preferably a turboreactor engine, comprising at least one shaft, in which the pressurization of oil taken from a reservoir, the distribution of the oil via a downstream circuit to elements of the said engine, and the return of the oil via a recovery circuit to the reservoir are ensured by means of a pump.

In a particularly advantageous manner, the rotational speed of said pump is variable and adjustable and preferably independent of the rotational speed of the engine shaft.

The process advantageously consists in monitoring and regulating the rotational speed of said pump by means of a control system preferably given in the form of a predetermined law in order to adapt to the actual lubrication needs of said engine.

The regulation is preferably based on preestablished laws concerning oil requirement as a function of the flight characteristics, the operating characteristics of the aircraft engine and/or the hydraulic characteristics of the pump.

According to a first embodiment, said regulation of the pump speed is carried out according to an open-loop logic.

According to another embodiment, said regulation of the pump speed is carried out according to a closed-loop logic.

According to another embodiment, said regulation of the pump speed is carried out according to a fuzzy logic.

The open-loop regulation of the speed is also advantageously based on one or more engine parameters such as the pressure, the temperature, the shaft speed and the mechanical load.

The closed-loop regulation of the speed is also advantageously based on a temperature, preferably the oil temperature, measured at at least one point on the engine.

The closed loop may be made by proportional/derivative action or PID action.

The present invention also relates to a lubrication device comprising at least one pump, for an aircraft engine, preferably a turboreactor engine, comprising at least one shaft, said device ensuring the pressurization of oil taken from a reservoir, the distribution of the oil, via a downstream circuit, to elements of said engine, and the return of the oil, via a recovery circuit, to the reservoir, after recovery of said oil in pan sections of said engine, characterized in that the rotational speed of said pump is variable and adjustable, independently of the rotational speed of the engine shaft, and in that it comprises means for monitoring and regulating the rotational speed of the pump, said speed being controlled, preferably via a predetermined law, by the flight characteristics, the operating characteristics of said aircraft engine and the hydraulic characteristics of the pump.

Advantageously, said pump forms part of a variable-speed motor-pump assembly, preferably located directly on the oil reservoir.

Preferably, the pump for the device according to the invention is driven by a source of energy which may consist, for example, of a generator, preferably coupled to the aircraft engine, or alternatively of a hydraulic or pneumatic system.

In a particularly advantageous manner, the device comprises means for regulating the speed of the pump which act according to an open-loop logic, closed-loop logic or which are based on fuzzy logic.

Preferably, the regulation is also based on preestablished laws concerning oil requirement as a function of the flight characteristics, the operating characteristics of the aircraft engine and the hydraulic characteristics of the pump.

The open-loop speed regulation is also advantageously based on one or more engine parameters such as the pressure, the temperature, the shaft speed and the mechanical load.

The closed-loop speed regulation is also advantageously based on a temperature, preferably the oil temperature, measured at at least one point on the engine.

The closed loop may be made by proportional/derivative action or PID action.

In addition, according to the invention, with said pumps used individually or as an assembly, the lubricating device may comprise means for assigning to each pump or assembly of pumps a specific lubrication task, each pump or assembly of pumps being regulated as a function of said specific task, independently of each other.

### BRIEF DESCRIPTION OF THE DRAWINGS

FIG. 1 is a schematic view of a device for lubricating an aircraft engine according to the prior art.

FIG. 2 is a schematic view of a device for lubricating an aircraft engine according to a first embodiment of the present invention.

FIG. 3 is a schematic view of a device for lubricating an aircraft engine according to a second embodiment of the present invention.

FIG. 4 is a schematic view of a device for lubricating an aircraft engine according to a third embodiment of the present invention.

### DETAILED DESCRIPTION OF THE INVENTION AND OF SEVERAL PREFERRED EMBODIMENTS

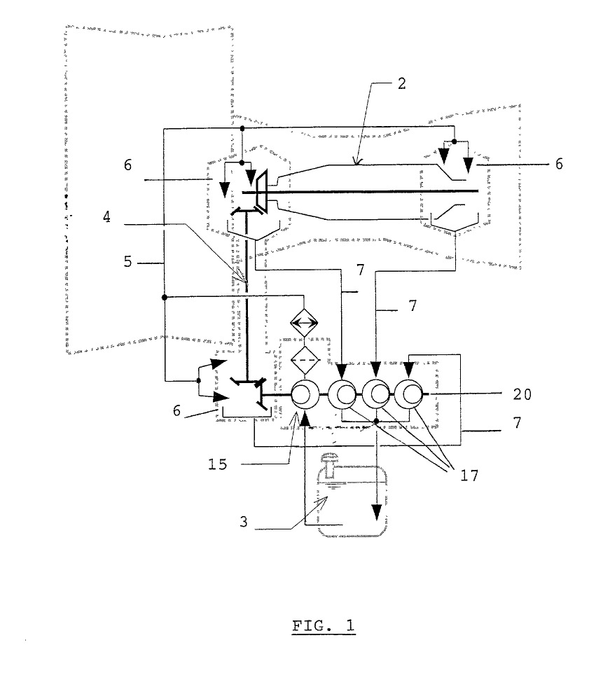

According to the prior art, as shown by the schematic view in FIG. 1, an assembly of lubrication pumps 15, 17 is arranged on a single shaft 20. This shaft is driven by a kinematic chain 4, which is in turn driven by the high-pressure shaft 2 of the engine.

The oil is first taken from the reservoir 3 and delivered by one or more pumps 15 to the various elements 6 to be lubricated, via a downstream circuit 5, and secondly recovered in the pan sections of the engine and returned by one or more pumps 17 to the reservoir 3, via a recovery circuit 7.

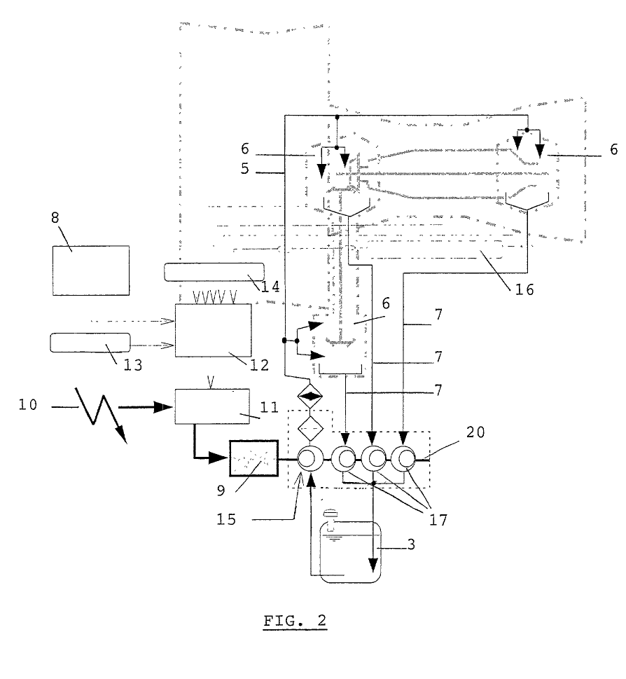

FIG. 2 is a diagram illustrating the general principles for the control of independently driven lubrication pumps, according to one preferred embodiment of the invention, in which all the pumps are grouped on a single shaft 20.

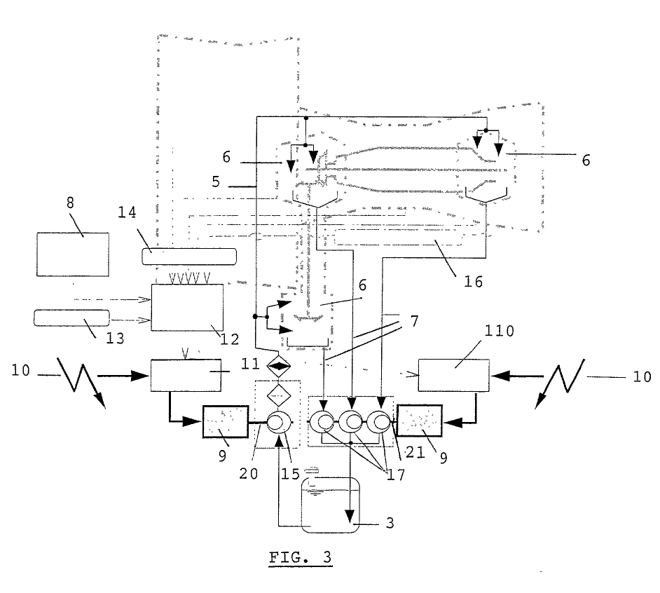

According to another specific embodiment of the invention shown in FIG. 3, the speed control unit 11 for the feed pump 15 is made separate from the common speed control unit 110 for all the recovery pumps 17, the two types of pumps being on different shafts 20, 21.

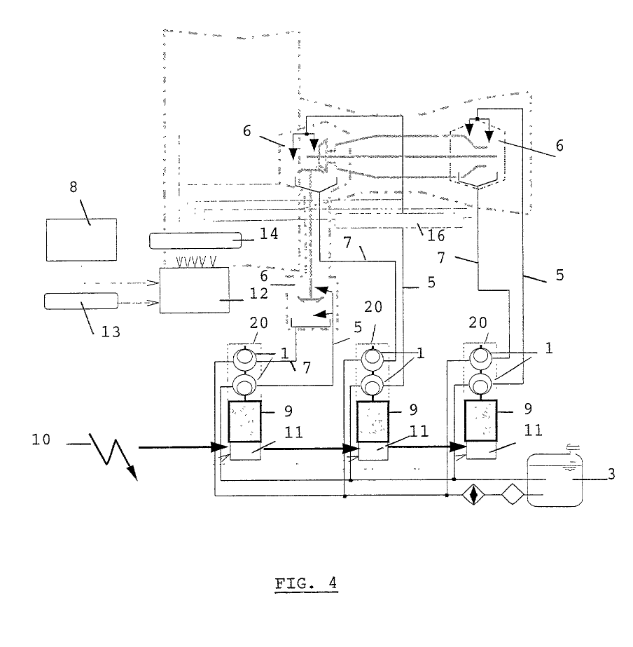

Finally, FIG. 4 shows another preferred embodiment of the invention, in which there is a control unit 11 for independent feed and recovery cells 1, 9 for each engine chamber 6.

In general, the invention may be applied to an assembly of pumps “arranged” on the same shaft, or alternatively individually to several pumps or sub-assembly of pumps, driven individually by an engine.

The principle underlying the invention is that of providing, by suitable means, at any point on the engine, for example directly on the oil reservoir, a variable speed motor pump assembly 9, 15, 17 (or 9, 1). This assembly preferably uses the electrical power supplied either by a generator 10 coupled to the aircraft engine, or any other source of electrical power available on the aircraft (hydraulic, pneumatic, etc.).

The speed of the motor-pump assembly (assemblies) is controlled according to a suitable logic 11, of one of the following types:

totally open-loop regulation, based on pre-established laws for engine oil requirement as a function of the flight conditions and operating conditions. The known hydraulic characteristics of the pump are incorporated. The input is the flight configuration and the system deduces therefrom an optimum rotational speed for the pump. The starting set value 12 is not readjusted as a function of the result. Delay or anticipation effects may be integrated to manage the thermal transients;

open-loop regulation from measurements of parameters 14 collected on the engine and indicative of the load and the powers dissipated by the elements to be lubricated (pressure and temperature of the engine 16, speed of the shaft 13, optionally engine load, etc.). The regulation system 11, 12 calculates the oil requirement from these data and integrates the pump characteristic. As previously, the control system may incorporate delay or anticipation effects;

closed-loop regulation on the temperature of the oil leaving the engine, or of that of elements to be lubricated, or alternatively of other points of the engine. This loop may be made by proportional/derivative/action, PID (proportional/integral/derivative) action or the like. This strategy has the advantage of automatically compensating up to a certain point for wear or accidental degradation of the pump;

fuzzy-logic or self-adaptive regulation, designed on the basis of acquired experience.

The calculations of the rotational speed of the pump to be carried out and of the control system functions 11, 12 may be executed entirely by the central processor 8 of the engine (FADEC) or by a processor specific to the pump or the lubricating device, or alternatively may be divided between these two processors.

The invention has a certain number of advantages over the prior art. The increase in mass brought about by the variable speed engine, which is preferably, but not necessarily, an electric motor, is largely compensated for by the lightening of the kinematic driving chain according to the prior art, as well as by the lightening of all the lubrication circuit and accessories which is made possible.

It is also possible to conserve a pump which is hydraulically simple, light and reliable. The pump driving motor and its control device may thus be produced with a lower mass than and a reliability at least equal to those of the kinematic chain they replace.

Furthermore, the current trend is to increase the electrical power needs of future engines and aircraft, as well as to extend the computerized control of the engine. It is consequently found that most of the equipment means required to supply power and set speeds to the pump are already present—or will soon be present —on engines. The increase in mass and in cost of the proposed solution is thus marginal for these items of equipment, whereas a large gain in mass and cost is, on the other hand, produced by dispensing with mechanical driving elements, making the pump itself and the associated circuit lighter.

The device according to the invention also makes it possible, on account of its greater flexibility and its reduced oil consumption, to improve the total output of the engine.

Finally, the invention allows more flexible strategies for adapting to degraded functioning than in the solutions of the prior art, and thus better reliability.

What is claimed is:

1. A lubrication device for an engine, comprising at least one engine shaft, said device comprising:
a reservoir;
a downstream circuit;
an upstream circuit, and
at least one pump, wherein said pump pressurizes oil taken from said reservoir, distributes said oil via said downstream circuit to elements of said engine, and returns said oil via said upstream circuit to said reservoir, after recovering said oil in pan sections of said engine;
wherein the rotational speed of said pump is variable and adjustable, independent of the rotational speed of the engine shaft, said device comprising components for regulating the speed of the pump taking into account the actual lubrication needs of the engine.

2. The device of claim 1, wherein said pump forms part of a variable speed motor-pump assembly.

3. The device of claim 2, wherein said pump is driven by a power supply.

4. The device of claim 3, wherein said power supply comprises a generator.

5. The device of claim 4, wherein said generator is coupled to said engine.

6. The device of claim 1, wherein said pump is actuated by an energy source.

7. The device of claim 6, wherein said energy source comprises a hydraulic system.

8. The device of claim 6, wherein said energy source comprises a pneumatic system.

9. The device of claim 1, further comprising a control system, wherein said control system regulates the speed of said pump.

10. The device of claim 1, wherein said rotational speed of said pump is variable and adjustable as a function of the flight characteristics, the operating characteristics of the engine, and the hydraulic characteristics of said pump.

11. The device of claim 1, wherein said rotational speed of said pump is regulated using open-loop logic.

12. The device of claim 1, wherein said rotational speed of said pump is variable and adjustable as a function of at least one engine parameter.

13. The device of claim 12, wherein said at least one engine parameter is selected from the group consisting of pressure, temperature, shaft speed, and mechanical load.

14. The device of claim 1, wherein said rotational speed of said pump is regulated using closed-loop logic.

15. The device of claim 1, wherein said rotational speed of said pump is variable and adjustable as a function of temperature.

16. The device of claim 15, wherein said temperature is the oil temperature measured at at least one point on said engine.

17. The device of claim 14, wherein said rotational speed of said pump is regulated using proportional/derivative action.

18. The device of claim 14, wherein said rotational speed of said pump is regulated using proportional/integral/derivative action.

19. The device of claim 1, wherein said rotational speed of said pump is regulated using self adaptive logic.

20. The device of claim 1, wherein said rotational speed of said pump is regulated using fuzzy logic.

21. The device of claim 1, further comprising components for assigning to each at least one pump at least one specific lubrication task, each at least one pump being regulated as a function of said specific task, independently of each other.

22. A device for lubricating an aircraft engine comprising at least one engine shaft and a plurality of engine chambers, said device comprising:
a reservoir;
a downstream circuit;
an upstream circuit, and
at least one pump for each engine chamber, wherein said at least one pump pressurizes oil taken from a reservoir, distributes said oil via said downstream circuit to each chamber of said engine, and returns said oil via said upstream circuit to said reservoir, after recovering said oil in pan sections of each chamber,
wherein the rotational speed of each pump is variable and adjustable, independent of each other.

23. A method for lubricating an aircraft engine, said engine comprising at least one engine shaft, comprising:
regulating the rotational speed of a pump in accordance with the lubrication needs of said engine, wherein said pump pressurizes oil taken from a reservoir of said engine, distributes said oil via a downstream circuit to elements of said engine and returns said oil via an upstream circuit to said reservoir.

24. The method of claim 23, wherein the rotational speed of said pump is regulated by a control system as a function of the operating characteristics of the engine and the hydraulic characteristics of said pump.

25. The method of claim 23, wherein said regulation of the speed of the pump is accomplished using open-loop logic.

26. The method of claim 25, wherein said regulation is based on one or more engine parameters.

27. The method of claim 26, wherein said one or more engine parameters are selected from the group consisting of pressure, temperature, shaft speed and the mechanical load of said engine.

28. The method of claim 23, wherein said regulation of the speed of the pump is accomplished using closed-loop logic.

29. The method of claim 28, wherein said regulation is based on the temperature measured at at least one point on the engine.

30. The method of claim 29, wherein said temperature is the oil temperature.

31. The method of claim 28, wherein said closed-loop is made using an action selected from the group consisting of proportional/derivative action and proportional/integral/derivative action.

32. The method of claim 23, wherein said regulation is accomplished using logic selected from the group consisting of fuzzy logic and self adaptive logic.
